(19) United States
(12) Patent Application Publication
(10) Pub. No.: US 2005/0156426 A1
(43) Pub. Date: Jul. 21, 2005

(54) Document holder

(76) Inventor: Chin-Chu Li, Taipei (TW)

Correspondence Address: APEX JURIS, PLLC, 13194 EDGEWATER LANE NORTHEAST, SEATTLE, WA, 98125, US

(21) Appl. No.: 10/760,008

(22) Filed: Jan. 15, 2004

(51) Int. Cl. B42D 17/00

(52) U.S. Cl. 281/45

(57) ABSTRACT

A document holder includes a plurality of holder bodies, a shaft assembly and a plurality of pivot modules. Each holder body has an adapting part for stacking the holder bodies. The shaft assembly inserts in the adapting part of the bottommost holder body. A first pivot part is further formed on a top of the shaft assembly in a vertical direction. The pivot modules respectively connect to the holder bodies except the bottommost holder body. Each pivot module has a second pivot part at its top and a matching part at its bottom in the vertical direction. The second pivotal parts of the holder bodies and the adapting part of the shaft assembly pivotally connect to one another to form a vertical pivot shaft via the matching parts to allow the rotation of the holder bodies around the vertical pivot shaft.

### BACKGROUND OF THE INVENTION

1. Field of the Invention

The invention relates to a document holder, and particularly to a document holder having multi-level holder bodies capable of rotating in a horizontal direction.

2. Description of the Related Art

Document holders are widely used in offices for placement of documents. Referring to FIG. 1, a conventional document holder includes a plurality of trays 5 and a plurality of connecting rods 6. Each of the trays 5 has a base plate (not shown), and a pair of lateral plates 52 formed on opposite sides thereof. Each connecting rod 6 connects two adjacent trays 5 by respectively mounting two ends of the connecting rod 6 on the lateral plates 52.

In the conventional document holder, the trays 5 elevate as the connecting rods 6 are pushed backward. Due to the single-direction unfolding of the holder, a significant large space is usually needed for using the holder, causing inconveniency in a limited office space.

Therefore, there is a need for a space-saving document holder that overcomes the above problems.

### SUMMARY OF THE INVENTION

It is therefore one object of the invention to provide a document holder having holder bodies capable of rotating in a horizontal direction for convenient access to documents.

To accomplish the above and other objectives, a document holder includes a plurality of holder bodies, a shaft assembly and a plurality of pivot modules. Each holder body has an adapting part for mounting the holder bodies over one another. The shaft assembly inserts in the adapting part of the bottommost holder body. A first pivot part is further formed on a top of the shaft assembly in a vertical direction. The pivot modules respectively connect to the holder bodies except the bottommost holder body. Each pivot module has a second pivot part at its top and a matching part at its bottom in the vertical direction. The second pivotal parts of the holder bodies and the adapting part of the shaft assembly pivotally connect to one another to form a vertical pivot shaft is via the matching parts to allow the rotation of the holder bodies around the vertical pivot shaft.

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is a side view of a conventional document holder;

FIG. 2 is an exploded view of a document holder according to one embodiment of the invention;

FIG. 3 is a perspective view of a document holder according to one embodiment of the invention;

FIG. 4 is a perspective view of holder bodies of a document holder according to one embodiment of the invention;

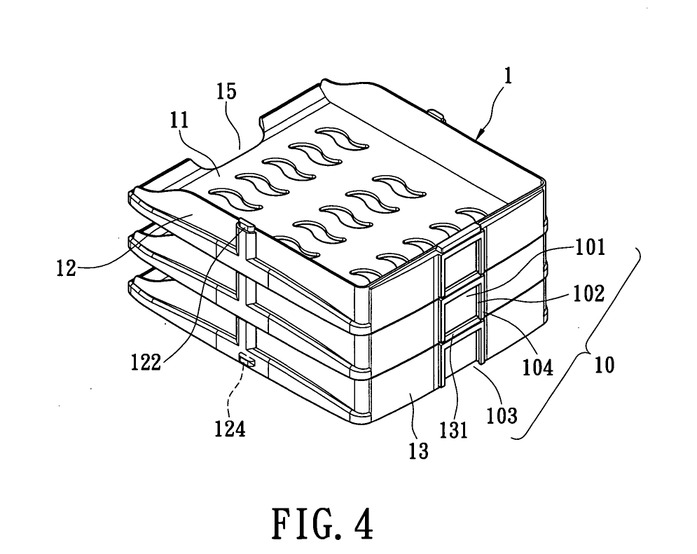

FIG. 5 is an exploded view of a document holder assembled with a fastener according to one embodiment of the invention; and

FIG. 6 is a perspective view of a document holder assembled with a fastener according to one embodiment of the invention.

### DETAILED DESCRIPTION OF THE EMBODIMENTS

Wherever possible in the following description, like reference numerals will refer to like elements and parts unless otherwise illustrated.

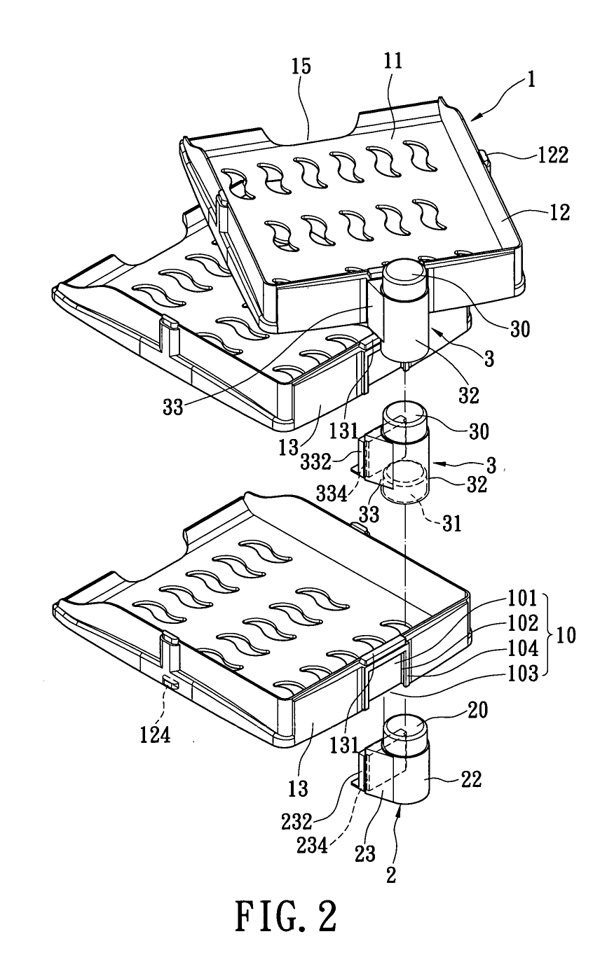

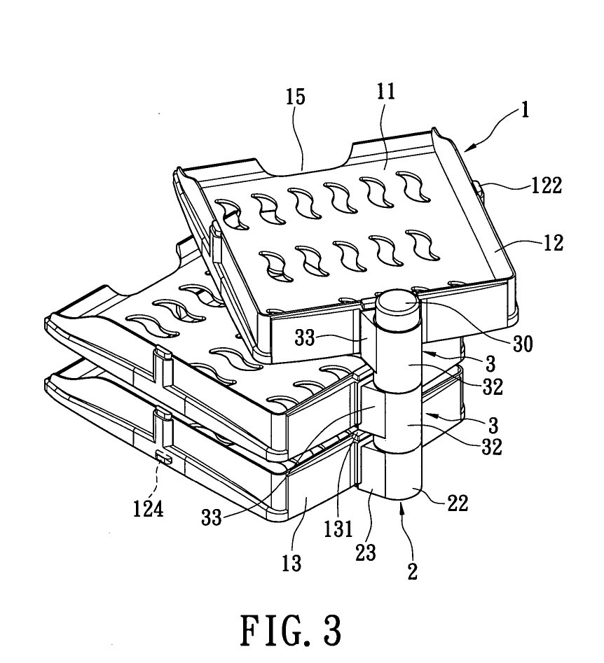

Referring to FIG. 2 and FIG. 3, a document holder of the invention includes a plurality of holder bodies 1, a shaft assembly 2 and a plurality of pivot modules 3.

The holder bodies 1 are mounted to one another in different levels along a vertical direction. Each holder body 1 has an adapting part 10 and a base plate 11. In this embodiment, the base plate 11 is a rectangular body. A rear plate 13 is mounted in a manner to extend from, a rear side of the base plate 11. An indentation 15 is formed at a front side of the base plate 11. A lateral plate 12 extends from each longitudinal side of the base plate 11. The adapting part 10 has a recess 101 on an outer surface of the rear plate 13. The recess 101 has a pair of opposite rails 102 and a pair of opposite frames 104. The recess 101, the rails 102 and the frames 104 together define an opening 103.

The shaft assembly 2 is mounted in the adapting part 10. A first pivotal part 20 is formed at a top of the shaft assembly 2 in the vertical direction. The first pivotal part 20 is, for example, a column protruding from the top of the shaft assembly 2.

The pivot modules 3 insert into the adapting parts 10 of the holder body 1, except the bottommost holder body 1. Each pivot module 3 has a second pivot part 30 on its top. The second pivot part 30 is, for example, a column protruding from the top. A bottom of each pivot module 3 is provided with a matching part 31 vertical to a bottom of the adapting module 3. The matching part 31 is, for example, a concave.

The shaft assembly 2 has a shaft body 22, and a first supporting arm 23. Each pivot module 3 has a pivoting body 32 and a second supporting arm 33. The first and second pivot parts 20, 30 are respectively mounted on the shaft body 22 and the pivoting body 32. The matching part 31 is mounted under the pivoting body 32 (in this embodiment, in the concave). The first and second supporting arms 23, 33 connect to peripheries of the shaft body 22 and the pivoting body 32. The first and second supporting arms 23, 33 are accommodated in the recess 101 via the opening 103 of the adapting part 10. On a rear side of the first supporting arm 23 is formed a pair of opposite first tracks 232 and a pair of opposite first grooves 234 to mach the rails 102 and the frames 104. On a rear side of each second supporting arm 33 is formed a pair of opposite second tracks 332 and a pair of opposite second grooves 334 to match the rails 102 and the frames 104.

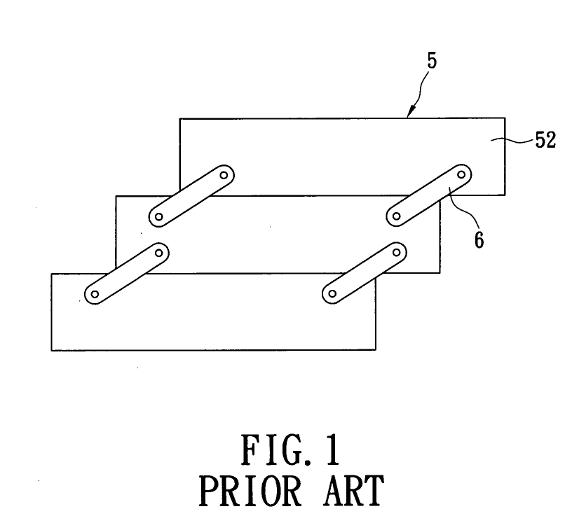

The second pivotal parts 30 of the holder bodies 1 and the adapting part 20 of the shaft assembly 2 pivotally connect to one another to form a vertical pivot shaft via the matching parts 31. That is, the column inserts in the concave of the next holder body so that the holder bodies can pivotally rotate. With the pivotal mount of the shaft assembly 2 and pivot modules 3 with the holder bodies 1, the holder bodies 1 freely rotates around the vertical shaft, in contrast to the one-direction rotation in the prior art as shown in FIG. 1. Therefore, the usage space of the document holder is effectively saved. Furthermore, the shaft is formed at a side of each holder body 1. The rotation of the holder bodies 1 brings the holder bodies 1 close to the user and thus allows convenient access to documents.

The rear plate 13 of each holder body 1 has strips 131 at its top to correspond to the opening 103. At least one flange 122 is formed at a periphery of each lateral plate 122. At least a slot 124 is formed at a bottom periphery of each lateral plate 12 to correspond to the flange 122. The pivoting body 32 has a height greater than the sum of the heights of the rear plate 13 and the strip 13 1, and also greater than the sum of the height of the lateral plate 12 and the flange 122. Thereby, the strip 131 and the flange 122 at a lower level engage with the opening 103 and the slot 124 at a higher level to provide a simple assembly of the document holder.

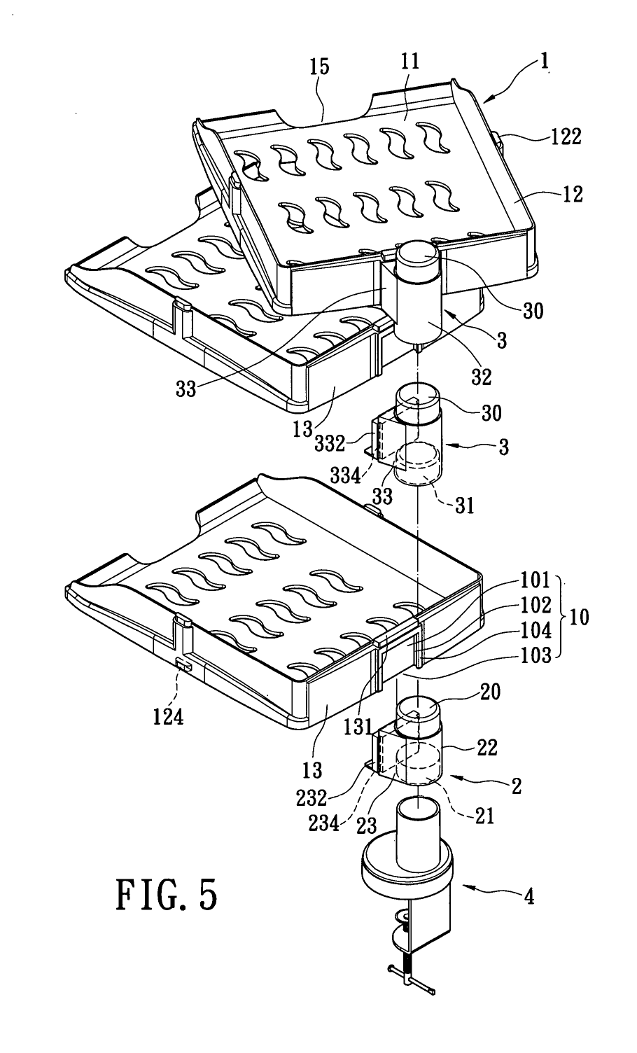

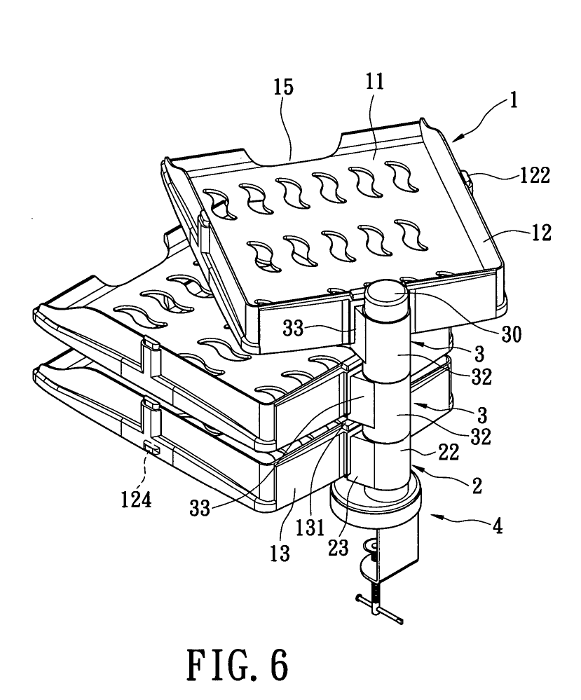

Referring to FIG. 5 and FIG. 6, a receiving part 21 is further formed at a bottom of the shaft assembly 2 in the vertical direction. The document holder further has a fastener 4 a top of which pivotally connects to the receiving part 21 so that the document holder can be fastened on an edge of a desk.

As described above, the document holder of the invention has advantages as follows.

1. The holder bodies are assembled over one another by being connected to the shaft assembly and the pivot modules, so that the holder bodies can rotate around the vertical shaft formed by the shaft assembly and the pivot modules with saved use space.

2. The horizontal rotation of the holder bodies allows convenient access to the documents.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

1. A document holder comprising:
a plurality of holder bodies mounted to one another in a vertical direction, and each of the holder bodies having an adapting part, which has a recess formed on a rear thereof;
a shaft assembly arranged in the adapting part of the a bottommost one of the holder bodies, and the shaft assembly having a first pivot part formed on a top thereof in the vertical direction and a first supporting arm accommodated in the recess of the bottommost one of the holder bodies; and
a plurality of pivot modules respectively connecting to the holder bodies except the bottommost one, wherein each of the pivot modules has a second pivot part at a top thereof and a matching part at a bottom thereof in the vertical direction, and a second supporting arm accommodated in the respective recess;
wherein the first pivot part of the shaft assembly and the second pivot parts of each pivot modules pivotally connects to the matching parts of a neighbor one of the pivot modules so as to form a vertical pivot shaft for enabling the holder bodies to rotate in a horizontal direction.

2. The document holder of claim 1, wherein the first pivot part of the shaft assembly and the second pivot parts of the pivot modules are protruding columns, and the matching parts of the pivot modules are concaves.

3. The document holder of claim 1, wherein each of the holder bodies has a base plate, a rear plate upwardly extending from a rear side of the base plate; the recess is formed at an outer surface of the rear plate, and a pair of opposite rails and a pair of opposite frames arranged along a vertical direction of the recess, and an opening adjacent to a bottom end of the recess; the first supporting arm of the shaft assembly has a pair of opposite first tracks and a pair of opposite first grooves to match the rails and the frames of the adapting part, and the second supporting arm of each pivot module has a pair of opposite second tracks and a pair of opposite second grooves to match the rails and the frames of the adapting part.

4. The document holder of claim 3, wherein each rear plate has a strip at a top thereof to correspond to the opening, two lateral plates upwardly extended from two opposite sides of the base plate; the two lateral plates each has at least one flange formed at a periphery thereof and at least one slot being formed at a bottom periphery thereof to correspond to the flange; each pivot module has a pivoting body on which the second pivot part is mounted, the matching part being formed under the pivoting body, the pivoting body having a height greater than the sum of the heights of the rear plate and the strip and also greater than the sum of the heights of the lateral plate and the flange.

5. The document holder of claim 3, wherein each holder body has an indentation at a front thereof.

6. The document holder of claim 1, wherein the shaft assembly has a part formed at a bottom thereof in the vertical direction for pivotally connecting to a fastener.
